(19) United States
(12) Patent Application Publication
(10) Pub. No.: US 2003/0052798 A1
(43) Pub. Date: Mar. 20, 2003

(54) Airplane anti-hijack system

(76) Inventor: Loyal McKinley Hanson, Fallbrook, CA (US)

Correspondence Address: Mr. Loyal M. Hanson, P.O. Box 430, Fallbrook, CA, 92088-0430, US

(21) Appl. No.: 09/968,692

(22) Filed: Oct. 1, 2001

Related U.S. Application Data
(60) Provisional application No. 60/323,035, filed on Sep. 17, 2001.

(51) Int. Cl. G08B 21/00

(52) U.S. Cl. 340/945; 340/574; 340/540

(57) ABSTRACT

An airplane anti-hijacking system includes components on board an airplane for producing informational signals reflecting conditions on board the airplane. Communications equipment on board the airplane that can be activated by onboard airplane personnel (e.g., during a hijack attempt or other emergency), automatically sends the informational signals to a ground station or other remote station to provide real-time information to the remote station. One embodiment sends audio, video, and sensor information along with the cockpit audio and flight recorder information already being recorded by an onboard black box system, and the communications equipment can be activated by cockpit personnel, predetermined senior flight attendants, and onboard security personnel. Preferably, the communications equipment on board the airplane is adapted to provide two-way communications with the remote station and includes means for enabling personnel at the remote station to activate the communications equipment and to actuate control components on board the airplane that perform various onboard operations (e.g., dumping fuel, taking over flight control and flying the airplane by remote control, etc.).

### CROSS REFERENCE TO RELATED APPLICATION

This application claims the benefit of copending U.S. Provisional Application Serial No. 60/323,035 filed Sep. 17, 2001.

### BACKGROUND OF THE INVENTION

1. Technical Field

This invention relates generally to airplanes, and more particularly to an emergency system for thwarting terrorists and other hijackers of an airplane.

2. Description of Related Art

The term “airplanes” herein refers to commercial airliners and the like, including any airplane that can be piloted by one or more onboard pilots and used to transport passengers. Some such airplanes have an onboard black box system that includes recorders in one or more reinforced, fire-resistant boxes that are sometimes referred to as “black boxes.” Cockpit conversations and flight data are recorded so that they can be recovered by ground personnel in the event the airplane crashes. Although helpful in determining just what occurred on board the airplane prior to a crash, the black box system does little to thwart terrorists or other hijackers at the time a plane is being hijacked. Passenger and luggage searches, sky marshals or other onboard security personnel, SWAT team efforts, Delta Force tactics, and other techniques have also proven of limited effectiveness in some respects, especially when the hijackers intend kamikaze-style use of the plane they have hijacked. They simply use the airplane as a missile that they aim at something they have targeted without regard for their life. Thus, a better way to thwart terrorist activities on board an airplane is needed.

### SUMMARY OF THE INVENTION

This invention addresses the concerns outlined above by providing an anti-hijacking system that includes anti-hijacking equipment on board an airplane for sending real-time onboard information via a two-way communications link to a ground station or other remote station apart from the airplane. Personnel at the remote station use computer equipment connected to remote station communications equipment in order to monitor and record conditions on board the airplane. They can send commands back to the airplane to perform various onboard anti-hijacking operations (e.g., dump fuel, take over flight control, etc.). Preferably, the communications link can be activated by a pilot or other onboard crew member in an emergency situation, or when otherwise desired, using an onboard turn-on feature of the invention. Preferably, it can be activated by ground personnel using a ground station turn-on feature.

To paraphrase some of the more precise language appearing in the claims, an airplane anti-hijacking system includes components on board an airplane for producing informational signals reflecting conditions on board the airplane. Communications equipment on board the airplane that can be activated during a hijack attempt or other emergency by onboard airplane personnel, or by personnel at a remote station (e.g. a ground controller), automatically sends the informational signals to a ground station or other remote station to provide real-time information to the remote station.

One embodiment sends audio, video, and sensor information along with the cockpit audio and flight recorder information already being recorded by an onboard black box system, and the communications equipment can be activated by cockpit personnel, predetermined senior flight attendants, and onboard security personnel. Preferably, the communications equipment on board the airplane is adapted to provide two-way communications with the remote station and includes means for enabling personnel at the remote station to activate the communications equipment and to actuate control components on board the airplane that perform various onboard operations (e.g., dumping fuel, controlling flight, and destroying the airplane). In other words, personnel at the remote station can monitor onboard activities and, if desired, take over flight control from those on board the airplane (including preventing onboard flight control), and fly the airplane by remote control.

Thus, the invention provides a better way to thwart hijacking attempts where the hijackers intend kamikaze-style use of the plane they have hijacked. The following illustrative drawings and detailed description make the foregoing and other objects, features, and advantages of the invention more apparent.

### BRIEF DESCRIPTION OF THE DRAWINGS

FIG. 1 of the drawings is a diagrammatic representation of a commercial airplane outfitted with an anti-hijacking system constructed according to the invention;

FIG. 2 is a block diagram providing details of the onboard equipment; and

FIG. 3 is a block diagram providing a further explanation of the ground station equipment.

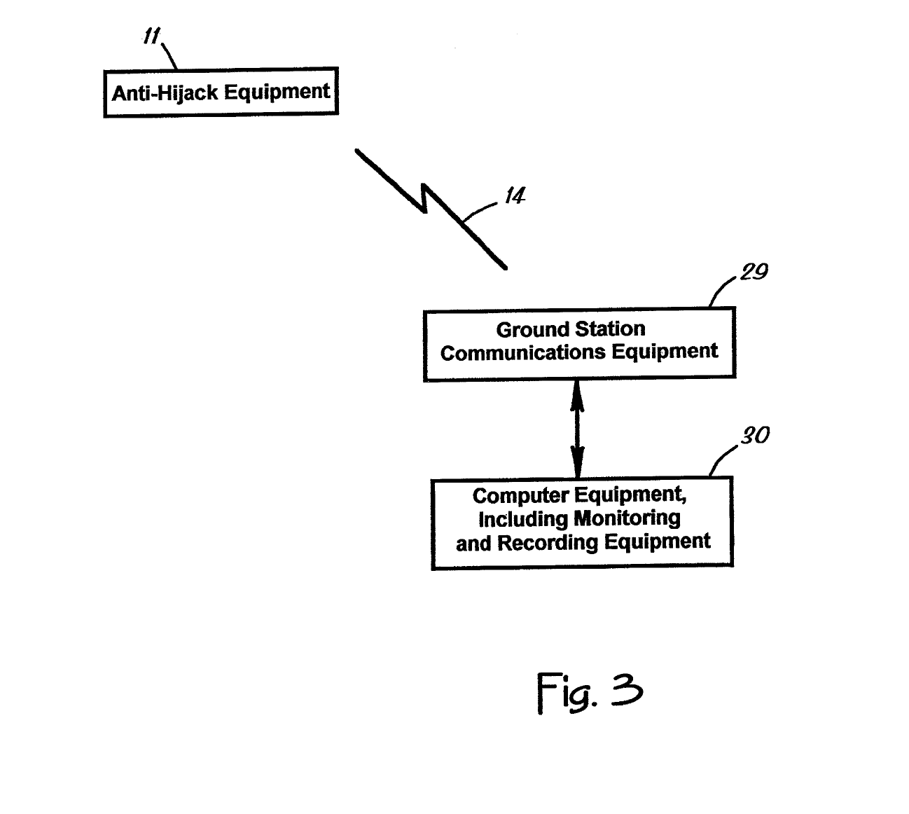

### DESCRIPTION OF THE PREFERRED EMBODIMENTS

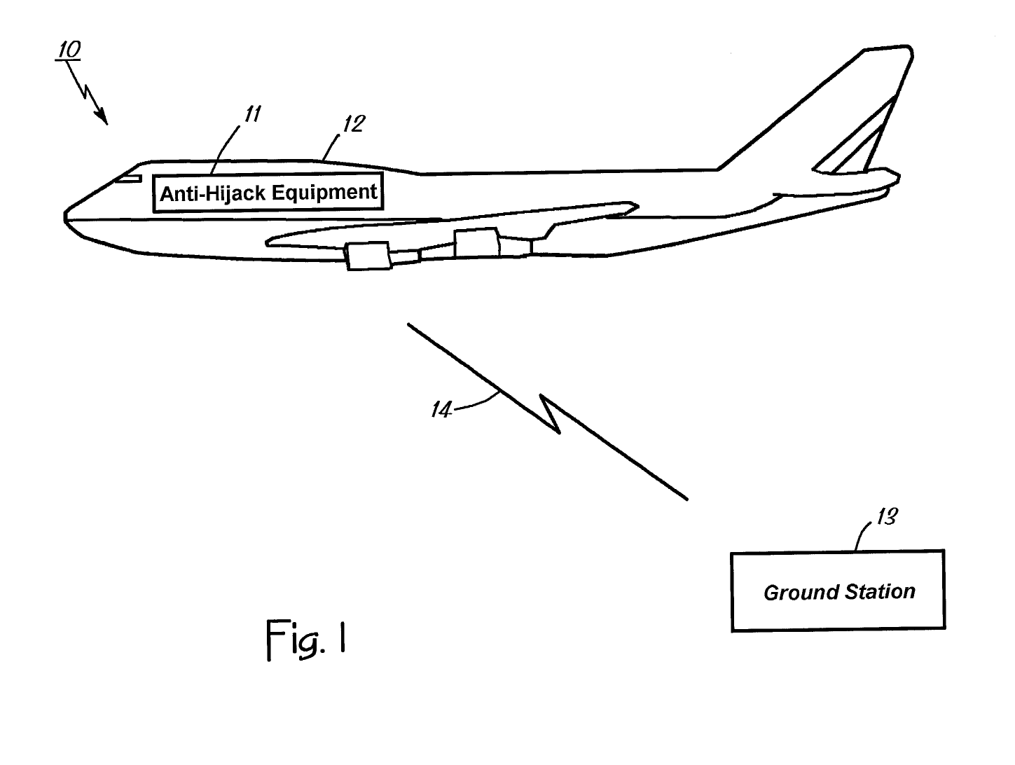

FIG. 1 of the drawings shows an airplane anti-hijack system 10 constructed according to the invention. Generally, the system 10 includes anti-hijack equipment 11 on board an airplane 12, a ground station 13 or other remote station (i.e., a station not on the airplane 12), and a two-way communications link 14 for communicating between the anti-hijack equipment 11 and the ground station 13. The communication link 14 may include any of various known communications components and techniques (e.g., a satellite link, a laser link, encryption techniques, etc.). The onboard anti-hijack equipment 12 and equipment at the ground station 13 may also include many known components and employ many known techniques.

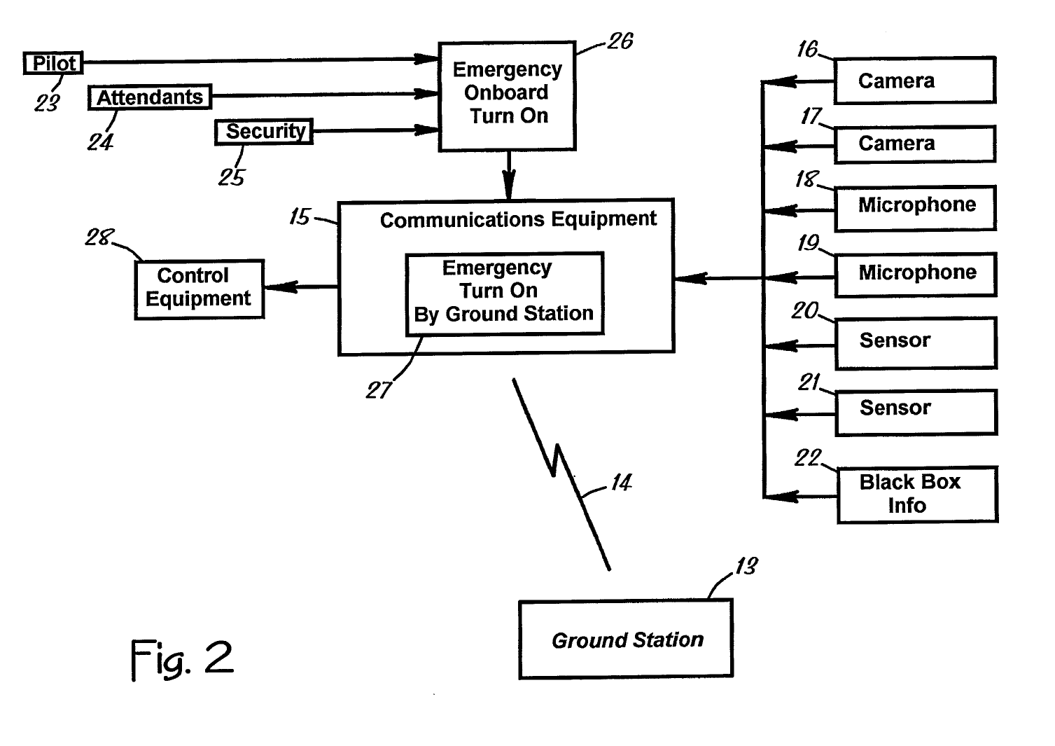

FIG. 2 focuses on the anti-hijack equipment 11. First, it includes communications equipment 15 on board the airplane 12 that is adapted to communicate (transmit) via the communication link 14 to the ground station 13. In addition, it includes at least one, but preferably several, input devices. The one or more input devices function as means on board the airplane 12 for producing informational signals reflecting conditions on board the airplane 12 (e.g., audio, video, smoke level, oxygen level, temperature, or other information). The system 10 includes multiple input devices for that purpose in the form of at least two cameras 16 and 17, two microphones 18 and 19, two sensors 20 and 21. They may all be known types of input devices and they are located at suitable locations about the airplane 12 to acquire desired anti-hijack information (i.e., information that may be useful in thwarting the hijacker's efforts). Those input devices are coupled to the communications equipment 15 along with cockpit audio and flight data from black box info input devices 22 that are already providing data to an onboard black box system (not shown). The communications equipment 15 functions as means on board the airplane 12 for communicating the informational signals produced by the various input devices to a remote station (i.e., the ground station 13).

The anti-hijack equipment 11 includes means on board the airplane 12 for enabling airplane personnel on board the airplane 12 to activate the communications equipment 15 in order to provide real-time information from the input devices to the ground station 13 or other remote station. They can activate it in the sense that they can cause it to communicate the informational signals produced by the various input devices to a remote station (i.e., transmit the information). Various means may be employed within the inventive concepts disclosed. For the illustrated anti-hijack equipment 11, the means for doing this includes a pilot actuator 23, a flight attendant actuator 24, and an onboard security personnel actuator 25 that are all coupled to an emergency onboard turn on components 26 enabling those people to activate the communications equipment 15 in an emergency. The actuators may take any of various forms, including a panic button in the cockpit, a key switch operable by a predetermined senior flight attendant, and a small transmitter unit carried by onboard security personnel (not shown). Actuating the communications equipment 25 may serve as an emergency alarm to personnel at the ground station 13 that hijack activities or some other emergencies are in process.

According to another aspect of the invention, the communications equipment 15 on board the airplane 12 is adapted to provide two-way communications with the ground station 13 and it includes means for enabling personnel at the ground station 13 to activate the communications equipment 15. This is accomplished in the illustrated system 10 with an emergency-turn-on-by-ground-station component 27 of the communications equipment 15. It may be implemented by suitable known means (e.g., a suitably programmed controller). Under control of personnel at the ground station 13, a command is sent to the communications equipment 15 that the component 27 responds to by turning on the communications equipment 15 (e.g., from a standby receiving mode to a fully operational two-way mode). In other words, the communications equipment 15 operates in a standby receiving mode until it is activated (i.e., transmitter turned on), and then it switches to a fully operational two-way mode (transmitting and receiving).

According to still another aspect of the invention, the anti-hijack equipment 11 on board the airplane 12 includes control equipment 28 on board the airplane 12 that functions as means on board the airplane 12 for performing at least one onboard control operation under control of personnel at the ground station 13. Personnel at the ground station 13 send commands to the communications equipment 15 that result in control signals being sent to the control equipment 28. The control equipment 28 responds by performing the desired operation. For the illustrated system 10, the control equipment 28 functions as means on board the airplane 12 for enabling personnel at the ground station 13 to fly the airplane 12 by remote control.

In order to accomplish the above, the ground station 13 includes ground station communications equipment 29 that combines with computer equipment 30 for monitoring, recording, and enabling personnel to initiate ground-station-to-airplane-communications. Based upon the foregoing description and the drawings, one of ordinary skill in the art can readily implement an airplane anti-hijacking system according to the invention. It may include known components and use known communications techniques, surveillance techniques, and control system techniques. Existing automatic-pilot features and other onboard avionics can be controlled, for example.

Thus, the invention provides a better way to thwart hijacking attempts where the hijackers intend kamikaze-style use of the plane they have hijacked. Although an exemplary embodiment has been shown and described, one of ordinary skill in the art may make many changes, modifications, and substitutions without necessarily departing from the spirit and scope of the invention. The communications equipment may be activated by onboard or ground personnel before or shortly after take-off, for example, and be kept activated and transmitting information for ground station monitoring throughout the entire flight. That variation is intended to fall within the scope of the broader claims.

What is claimed is:

1. An airplane anti-hijacking system, comprising:
means on board an airplane for producing informational signals reflecting conditions on board the airplane, including at least one input device;
means on board the airplane for communicating the informational signals to a remote station, including communications equipment on board the airplane that is coupled to the input device; and
means on board the airplane for enabling airplane personnel on board the airplane to activate the communications equipment on board the airplane in order to provide real-time information from the input device to the remote station.

2. An airplane anti-hijacking system as recited in claim 1, wherein the means on board the airplane for producing informational signals reflecting conditions on board the airplane includes at least one video input device.

3. An airplane anti-hijacking system as recited in claim 1, wherein the means on board the airplane for producing informational signals reflecting conditions on board the airplane includes at least one audio input device.

4. An airplane anti-hijacking system as recited in claim 1, wherein the means on board the airplane for producing informational signals reflecting conditions on board the airplane includes at least one sensor device.

5. An airplane anti-hijacking system as recited in claim 1, wherein the means on board the airplane for producing informational signals reflecting conditions on board the airplane includes existing onboard equipment providing audio and flight recorder signals for recording by a black box on board the airplane.

6. An airplane anti-hijacking system as recited in claim 1, wherein the means on board the airplane for enabling airplane personnel on board the airplane to activate the communications equipment on board the airplane includes means for enabling cockpit personnel on board the airplane to activate the communications equipment in an emergency.

7. An airplane anti-hijacking system as recited in claim 1, wherein the means on board the airplane for enabling airplane personnel on board the airplane to activate the communications equipment on board the airplane includes means for enabling predetermined senior flight attendants to activate the communications equipment in an emergency.

8. An airplane anti-hijacking system as recited in claim 1, wherein the means on board the airplane for enabling airplane personnel on board the airplane to activate the communications equipment on board the airplane includes means for enabling onboard security personnel to activate the communications equipment in an emergency.

9. An airplane anti-hijacking system as recited in claim 1, wherein the communications equipment on board the airplane is adapted to provide two-way communications with the remote station and includes means for enabling personnel at the remote station to activate the communications equipment.

10. An airplane anti-hijacking system as recited in claim 9, wherein the anti-hijacking system includes control means on board the airplane for performing at least one onboard control operation under control of personnel at the remote station, and the communications equipment on board the airplane is adapted to enable personnel at the remote station to actuate the control means.

11. An airplane anti-hijacking system as recited in claim 9, further comprising a remote station having communications equipment and computer equipment with monitoring equipment and recording equipment coupled to the communications equipment.

12. An airplane anti-hijacking system, comprising:
means on board an airplane for producing informational signals reflecting conditions on board the airplane, including at least one input device;
means on board the airplane for communicating the informational signals to a remote station, including communications equipment on board the airplane that is coupled to the input device; and
means on board the airplane for enabling personnel at the ground station to fly the airplane by remote control.

13. An airplane anti-hijacking system, comprising:
means on board an airplane for producing informational signals reflecting conditions on board the airplane, including at least one input device;
means on board the airplane for communicating the informational signals to a remote station, including communications equipment on board the airplane that is coupled to the input device; and
means on board the airplane for enabling personnel at the remote station to fly the airplane by remote control.

14. An airplane anti-hijacking system, comprising:
means on board an airplane for producing informational signals reflecting conditions on board the airplane, including at least one input device in the form of a camera; and
means on board the airplane for communicating the informational signals to a remote station, including communications equipment on board the airplane that is coupled to the input device.

15. An airplane anti-hijacking system as recited in claim 14, wherein the communications equipment on board the airplane is adapted to provide two-way communications with the remote station and includes means for enabling personnel at the remote station to activate the communications equipment.

16. An airplane anti-hijacking system as recited in claim 14, further comprising means on board the airplane for enabling airplane personnel on board the airplane to activate the communications equipment on board the airplane in order to provide real-time information from the input device to the remote station.
